(19) United States
(12) Patent Application Publication
(10) Pub. No.: US 2019/0089759 A1
(43) Pub. Date: Mar. 21, 2019

(54) VIDEO ENCODING CIRCUIT AND WIRELESS VIDEO TRANSMISSION APPARATUS AND METHOD

(71) Applicant: Novatek Microelectronics Corp., Hsinchu (TW)

(72) Inventors: Po-Chun Yeh, Hsinchu City (TW); Chia-Chuan Cho, Hsinchu County (TW); He-Shuen Kang, Hsinchu City (TW); Jen-Wei Liang, Taipei City (TW)

(73) Assignee: Novatek Microelectronics Corp., Hsinchu (TW)

(21) Appl. No.: 16/009,205

(22) Filed: Jun. 15, 2018

Related U.S. Application Data
(60) Provisional application No. 62/560,138, filed on Sep. 18, 2017.

(51) Int. Cl. H04L 29/06; H04N 19/114; H04N 19/177; H04N 19/187

(52) U.S. Cl. CPC H04L 65/607; H04N 19/187; H04N 19/177; H04N 19/114

(57) ABSTRACT

The present disclosure provides a video encoding circuit and a wireless video transmission apparatus and method. The wireless video transmission apparatus includes a wireless transmitter circuit and a video encoding circuit. The wireless transmitter circuit is configured to transmit a video stream with a bit rate to a wireless transmission channel and provide a transmission state message according to a transmission state of the wireless transmission channel. The video encoding circuit is coupled to the wireless transmitter circuit to receive the transmission state message. The video encoding circuit is configured to perform an encoding operation on video data to generate the video stream to the wireless transmitter circuit and dynamically adjust the bit rate of the video stream delivered to the wireless transmitter circuit according to the transmission state message.

### CROSS-REFERENCE TO RELATED APPLICATION

This application claims the priority benefit of U.S. provisional application Ser. No. 62/560,138, filed on Sep. 18, 2017. The entirety of the above-mentioned patent application is hereby incorporated by reference herein and made a part of this specification.

### BACKGROUND

### Field of the Invention

The invention relates to a video apparatus and more particularly, to a video encode circuit and a wireless video transmission apparatus and method.

### Description of Related Art

It is a common application to transmit H.264 video streams in a wireless manner through Wi-Fi. In a condition that an H.264 encoder in a general system is incapable of effectively discovering quality of a wireless channel, or no preferable adjustment mechanism is available, video quality of the encoder will obviously and rapidly deteriorated, or the videos even become totally unusable in the occurrence of a situation that a wireless channel bandwidth is narrowed or the quality of the wireless channel is poor. When the quality of the wireless channel turns better, a time required for recovering the video quality of the H.264 encoder in the general system also becomes relatively slow.

In a wireless video transmission system, a stream adjustment mechanism for the encoder has several defects as follows.

1. The conventional H.264 encoder is totally incapable of referring to any message about the quality of the wireless channel, and a stream flow of the conventional H.264 encoder remains fixed. In such situation, for an image to be completely transmitted to a receiving party as much as possible, the conventional H.264 encoder is often statically set to a relatively small stream flow. However, the relatively small stream flow represents that a currently available bandwidths cannot be sufficiently utilized, such that a chance for transmitting an image with better quality is lost.

2. Between a transmission party and the receiving party of the wireless channel, a feedback mechanism is conventionally established through a network layer of the same wireless channel. After the receiving party reports a reception state of the network layer to the transmission party through the wireless channel, the transmission party can correspondingly adjust the stream flow or a resolution. A problem of such system lies in that the feedback path is too long, while a response time is relatively slow. Furtheiniore, the stream and the feedback message are both transmitted through the same wireless channel, such that stabilization and reliability of the feedback mechanism are also influenced by the state of the wireless channel. In the presence of the unstable (unreliable) feedback message, the conventional H.264 encoder certainly cannot produce preferable stream adjustment behavior.

When the general wireless video transmission system transmitting the video stream by using Wi-Fi encounters poor quality of the wireless channel, both important and unimportant packets in the video stream has the same probability to be lost. Thus, a quality deterioration degree of the image of the general wireless video transmission system is incapable of being effectively controlled or mitigated. Moreover, it also usually results in broken images or image lags occurring at the receiving party. The quality of the image displayed at the receiving party is continuously obviously deteriorated along with the quality deterioration degree of the wireless transmission channel.

### SUMMARY

The invention provides a wireless video transmission apparatus, a video encoding circuit and a wireless video transmission method capable for dynamically adjusting a bit rate of a transmission state message provided by the wireless transmitter circuit.

According to an embodiment of the invention, a wireless video transmission apparatus is provided. The wireless video transmission apparatus includes a wireless transmitter circuit and a video encoding circuit. The wireless transmitter circuit is configured to transmit a video stream with a bit rate to a wireless transmission channel and provide a transmission state message according to a transmission state of the wireless transmission channel. The video encoding circuit is coupled to the wireless transmitter circuit to receive the transmission state message. The video encoding circuit is configured to perform an encoding operation on video data to generate the video stream to the wireless transmitter circuit. The video encoding circuit is configured to dynamically adjust the bit rate of the video stream delivered to the wireless transmitter circuit according to the transmission state message.

According to an embodiment of the invention, a video encoding circuit is provided. The video encoding circuit includes a scalable video encoding (SVC) circuit, a stream protocol circuit, a distributor circuit and a controller circuit. The SVC circuit is configured to perform an encoding operation on video data by using an SVC technique, so as to generate a plurality of packets. The packets have a group of pictures (GOP) structure, and a GOP in the GOP structure includes a plurality of layers. The stream protocol circuit is coupled to the SVC circuit to receive the packets. The stream protocol circuit is configured to define a first part of the layers to have a first level of importance and defines a second part of the layers to have a second level of importance lower than the first level of importance. The stream protocol circuit deteiniines whether to employ the packets belonging to the layers having the first level of importance as a video stream and drop the packets belonging to the layers having the second level of importance according to an adjustment signal. The distributor circuit is coupled to the stream protocol circuit to receive the video stream. The distributor circuit is configured to give importance definitions to different packets of the video stream, so as to at least divide the video stream into a first-priority stream and a second-priority stream. The distributor circuit is configured to output the first-priority stream and the second-priority stream to a wireless transmitter circuit. The controller circuit is coupled to the stream protocol circuit to provide the adjustment signal. The controller circuit controls the stream protocol circuit according to a transmission state message of the wireless transmitter circuit, so as to determine whether to drop the packets belonging to the layers having the second level of importance.

According to an embodiment of the invention, a wireless video transmission method is provided. The wireless video transmission method includes: transmitting a video stream with a bit rate to a wireless transmission channel by a wireless transmitter circuit; providing a transmission state message according to a transmission state of the wireless transmission channel by the wireless transmitter circuit; performing an encoding operation on video data to generate the video stream to the wireless transmitter circuit; and dynamically adjusting the bit rate of the video stream delivered to the wireless transmitter circuit according to the transmission state message of the video encoding circuit.

To sum up, the wireless video transmission apparatus, the video encoding circuit and the wireless video transmission method provided by the embodiments of the invention combine features of the wireless transmitter circuit and the video encoding circuit. The wireless transmitter circuit can provide the transmission state message to the video encoding circuit according to the transmission state of the wireless transmission channel. The video encoding circuit can dynamically adjust the bit rate according to the transmission state message. In the occurrence of poor quality of the wireless transmission channel, the bit rate of the video stream can be adaptively adjusted according to the transmission state of the wireless transmission channel, for example, by adjusting the operation parameters of the encoding operation and/or preferentially transmitting important pockets includes in the video stream. Thus, in the occurrence of the poor quality of the wireless transmission channel, the wireless video transmission apparatus and the video encoding circuit provided by the embodiments of the invention can achieve effectively improving image quality displayed at a receiving party.

To make the above features and advantages of the invention more comprehensible, embodiments accompanied with drawings are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic circuit block diagram illustrating a wireless video transmission apparatus according to an embodiment of the invention.

FIG. 2 is a flowchart illustrating a wireless video transmission method according to an embodiment of the invention.

FIG. 3 is a schematic circuit block diagram illustrating the wireless transmitter circuit depicted in FIG. 1 according to an embodiment of the invention.

FIG. 4 is a function explanatory diagram illustrating the group of pictures (GOP) structure of the encoding operation of the video encoding circuit depicted in FIG. 1 according to an embodiment of the invention.

FIG. 5 is a schematic circuit block diagram illustrating the video encoding circuit depicted in FIG. 1 according to an embodiment of the invention.

FIG. 6 is a flowchart illustrating a wireless video transmission method according to another embodiment of the invention.

### DESCRIPTION OF EMBODIMENTS

The term “couple (or connect)” herein (including the claims) are used broadly and encompass direct and indirect connection or coupling means. For example, if the disclosure describes a first apparatus being coupled (or connected) to a second apparatus, then it should be interpreted that the first apparatus can be directly connected to the second apparatus, or the first apparatus can be indirectly connected to the second apparatus through other devices or by a certain coupling means. Moreover, elements/components/steps with same reference numerals represent same or similar parts in the drawings and embodiments. Elements/components/notations with the same reference numerals in different embodiments may be referenced to the related description.

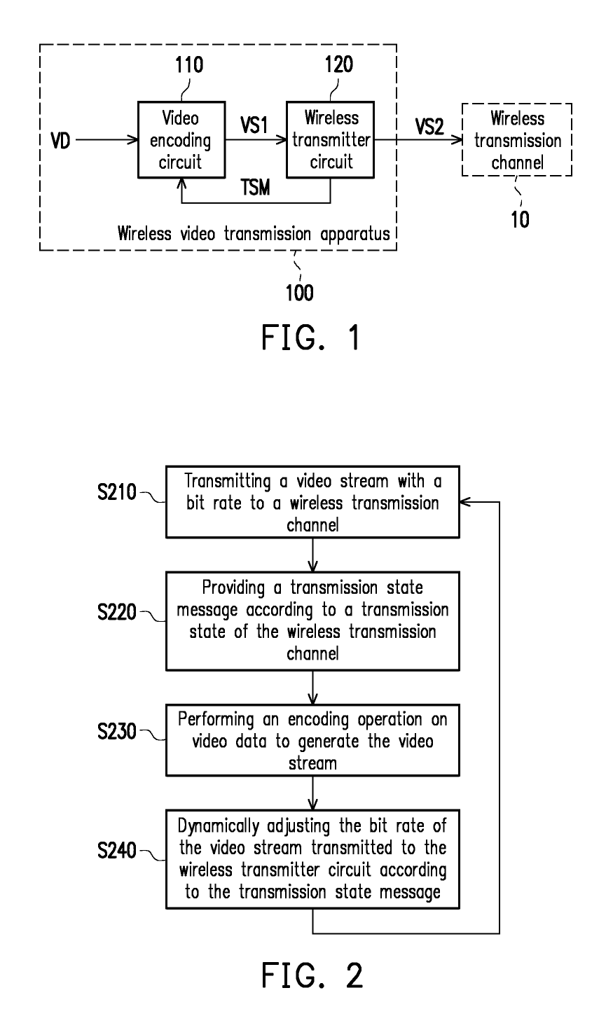

FIG. 1 is a schematic circuit block diagram illustrating a wireless video transmission apparatus 100 according to an embodiment of the invention. The wireless video transmission apparatus 100 includes a video encoding circuit 110 and a wireless transmitter circuit 120. The video encoding circuit 110 is configured to perform an encoding operation on video data VD to generate a video stream VS1 to be delivered to the wireless transmitter circuit 120 with a first bit rate. Based on a design requirement, the encoding operation may be any video encoding operation known in the art. For example, the encoding operation may be an H.264 scalable video encoding (SVC) operation or other encoding operations. One of the features of the SVC encoding operation is to distinguish each packet in accordance with different importance levels.

The wireless transmitter circuit 120 is coupled to the video encoding circuit 110 to receive the video stream VS1. The wireless transmitter circuit 120 is configured to transmit a video stream VS2 related to the video stream VS1 with a second bit rate to a wireless transmission channel 10, wherein the second bit rate depends at least upon the first bit rate. Based on a design requirement, the wireless transmitter circuit 120 may be any wireless communication interface circuit/element. For example, the wireless transmitter circuit 120 may be a Wi-Fi interface circuit or other wireless communication interface circuits. Thus, a receiving party (not shown) may receive the video stream VS2 output by the wireless video transmission apparatus 100 (i.e., a transmission party) through the wireless transmission channel 10.

FIG. 2 is a flowchart illustrating a wireless video transmission method according to an embodiment of the invention. FIG. 2 is explained with the embodiment shown in FIG. 1 but is not limited thereto. Referring to FIG. 1 and FIG. 2, in step S210, the wireless transmitter circuit 120 transmits the video stream VS2 with a first bit rate to the wireless transmission channel 10. In step S220, the wireless transmitter circuit 120 may provide a transmission state message TSM to the video encoding circuit 110 according to a transmission state of the wireless transmission channel 10. The video encoding circuit 110 is coupled to the wireless transmitter circuit 120 to receive the transmission state message TSM. In step S230, the video encoding circuit 110 may perform the encoding operation (e.g., an SVC encoding operation) on the video data VD to generate the video stream VS1 to the wireless transmitter circuit 120. In addition, the video encoding circuit 110 may dynamically adjust the first bit rate of the video stream VS1 delivered to the wireless transmitter circuit 120 according to the transmission state message TSM, so as to change the second bit rate of the video stream VS2 (step S240) transmitted to the wireless transmission channel.

In a practice of a general encoder, a complete encoded result is simply encoded by applying a stream protocol, for example, a real time streaming protocol (RTSP), and then transmitted to the receiving party. In a conservative consideration, the general encoder is typically set to a fixed and small stream flow. Thus, the general encoder usually fails to sufficiently utilize a currently available bandwidths and thus, loses a chance for transmitting an image with better quality. The video encoding circuit 110 illustrated in FIG. 1 may dynamically adjust the bit rate of the video stream according to the transmission state message TSM. Thus, the wireless video transmission apparatus 100 may actively reduce/increase demands for transmission bandwidths according to a transmission state of the wireless transmission channel 10 (which refers to transmission quality of the wireless transmission channel 10). The wireless video transmission apparatus 100 may sufficiently utilize the currently available bandwidths of the wireless transmission channel 10, thereby, well taking the chance for transmitting the image with better quality.

Furthermore, when a general system transmitting videos through Wi-Fi encounters poor quality of the wireless channel, important and unimportant packets have the same probability to be lost. Thus, a quality deterioration degree of images of the general Wi-Fi video transmission system is incapable of being effectively controlled or mitigated. The video encoding circuit 110 may distinguish each packet of the video stream VS1 in accordance with different importance levels. In some embodiments, the encoding operation performed by the video encoding circuit 110 may give importance definitions to different packets of the video stream VS1, so as to at least divide the video stream VS1 into at least one first-priority stream and at least one second-priority stream. Therein, the priority of the first-priority stream is higher than the priority of the second-priority stream. The wireless transmitter circuit 120 may provide protection in different degrees for the packets of the video stream VS1 which have different importance levels. When the wireless channel encounters conditions to cause poor transmission quality, it can be arranged that the more important packets have a much smaller probability to be lost than the less important packets. Thereby, the wireless video transmission apparatus 100 may achieve a better video transmission effect.

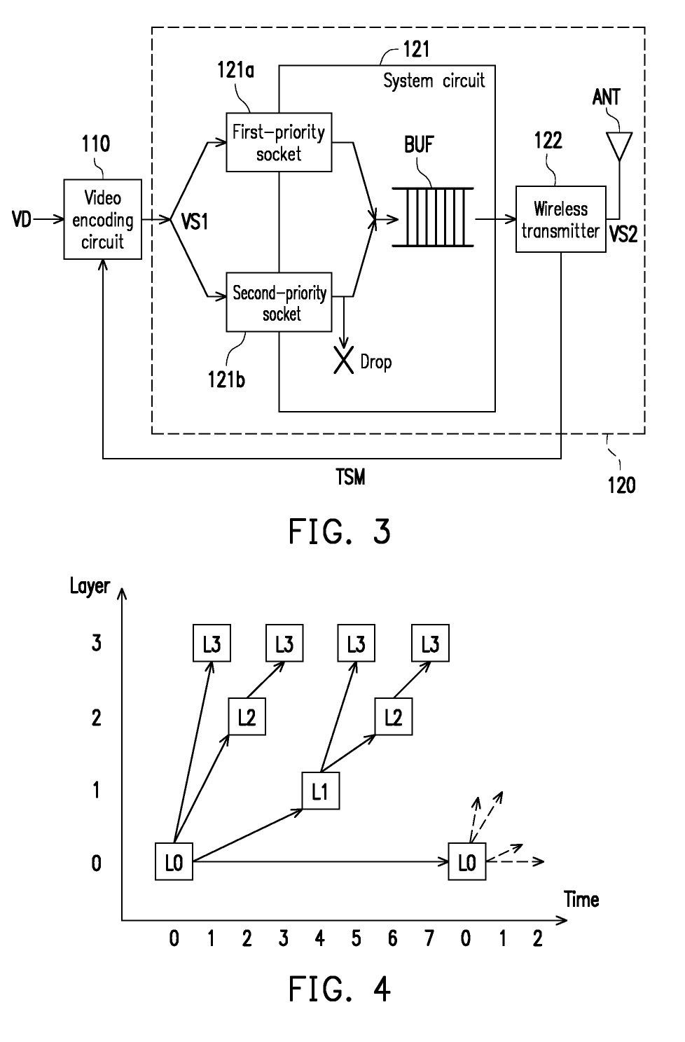

FIG. 3 is a schematic circuit block diagram illustrating a wireless transmitter circuit according to an embodiment of the invention. The wireless transmitter circuit can be implemented as the wireless transmitter circuit 120 depicted in FIG. 1 according to an embodiment of the invention but is not limited thereto. In the embodiment illustrated in FIG. 3, the wireless transmitter circuit 120 includes a system circuit 121, a wireless transmitter 122 and an antenna ANT. The system circuit 121 is coupled to the video encoding circuit 110 to receive the video stream VS1. The system circuit 121 provides a plurality of sockets with different priorities for receiving different streams of the video stream VS1, respectively. For example, the system circuit 121 as shown can provide a first-priority socket 121a for receiving the first-priority stream of the video stream VS1. The system circuit 121 provides a second-priority socket 121b for receiving the at least one second-priority stream of the video stream VS1. In addition, the system circuit 121 may provide a buffer memory BUF for temporarily storing the first-priority stream and the second-priority stream. The wireless transmitter 122 is coupled to the system circuit 121 to receive a stream temporarily stored by the buffering memory BUF. The wireless transmitter 122 may transmit the stream to the wireless transmission channel 10 through the antenna ANT. The wireless transmitter circuit 122 may provide the transmission state message TSM to the video encoding circuit 110 according to the transmission state of the wireless transmission channel 10.

Based on a design requirement, the wireless transmitter 122 may be an available Wi-Fi transmitter circuit known in the art or other wireless communication interface circuits. Based on a design requirement, the transmission state message TSM may include rate adaption information, a per-packet transmission (TX) status of each packet and/or other transmission state information. The rate adaption information may include a physical layer rate (PhyRate) or other transmission rate information. The PhyRate can be determined by a rate adaption operation performed by a media access control (MAC) circuit of the wireless transmitter 122. The “per-packet TX status” can be generated by the MAC circuit of the wireless transmitter 122. The “per-packet TX status” may include at least one of “whether to place per-packet into a queue”, “a count of the packets transmitted in the queue”, “a packet retry limit” and/or other packet transmission states. The MAC circuit, the rate adaption operation and the “per-packet TX status” can have available configurations known in the art.

In one embodiment, when a used space of the buffering memory BUF does not yet reach a first threshold, the system circuit 121 temporarily stores both the first-priority stream of the first-priority socket 121a and the second-priority stream of the second-priority socket 121b in the buffering memory BUF. The first threshold may be determined based on a design requirement. When the used space of the buffering memory BUF reaches the first threshold, the system circuit 121 temporarily stores the first-priority stream of the first-priority socket 121a in the buffering memory BUF and drops the second-priority stream of the second-priority socket 12 lb. In some other embodiments, when the used space of the buffering memory BUF reaches a second threshold (which is greater than the first threshold), the system circuit 121 may further clear the second-priority stream temporarily stored in the buffer memory BUF. The second threshold may be determined based on a design requirement.

Thereby, the wireless transmitter circuit 120 may provide protection in different degrees for the packets of the video stream VS1 which have different importance levels. When the wireless channel has poor quality, the packets with higher importance levels may be selectively transmitted, and the packets with lower importance levels may be selectively dropped if necessary, such that the demands for channel bandwidths may be instantly reduced while the protection of the transmission of the packets with high importance levels may be strengthened, and anti-noise capability of the video stream toward the wireless channel may be enhanced. In other words, the important packets can have a smaller probability to be lost than the unimportant packets. Thereby, the wireless video transmission apparatus 100 may achieve a better video transmission effect.

Referring to FIG. 1, the video encoding circuit 110 can correspondingly adjust one or more operation parameters of the encoding operation according to the transmission state message TSM of the wireless transmitter circuit 120, so as to dynamically adjust the bit rate of the video stream VS1 transmitted to the wireless transmitter circuit 120. The operation parameters of the encoding operation may be determined based on a design requirement. For example, the operation parameters may include a resolution parameter of the encoding operation, a quantization parameter of the encoding operation, a frame rate parameter of the encoding operation and/or other encoding operation parameters. The resolution parameter, the quantization parameter and the frame rate parameter are conventional and thus, will not be repeated.

The video encoding circuit 110 may dynamically adjust the bit rate of the video stream according to the transmission state message TSM. Namely, when the wireless channel has good quality, the video encoding circuit 110 may dynamically adjust the bit rate of the video stream VS1 (i.e., the bit rate of the video stream VS2) by adjusting the operation parameters of the encoding operation. When the wireless channel has poor quality, the video encoding circuit 110 may dynamically adjust the bit rate of the video stream VS1 (i.e., the bit rate of the video stream VS2) by adjusting the operation parameters of the encoding operation. Thereby, the wireless video transmission apparatus 100 may actively reduce/increase the demands for transmission bandwidths according to the transmission state of the wireless transmission channel 10 (i.e., the quality of the wireless transmission channel 10). The wireless video transmission apparatus 100 may sufficiently utilize the currently available bandwidths of the wireless transmission channel 10, thereby, well taking the chance for transmitting the image with better quality.

FIG. 4 is a function explanatory diagram illustrating the group of pictures (GOP) structure of the encoding operation of the video encoding circuit 110 depicted in FIG. 1 according to an embodiment of the invention. In FIG. 4, the horizontal axis represents a frame time sequence, and the vertical axis represents a plurality of layers of the GOP structure. The packets generated by the encoding operation have a plurality of layers. Taking a scalable video coding (SVC) technique defined by the H.264 /MPEG-4 standard for example, the video encoding circuit 110 may perform the encoding operation by using the SVC technique. The SVC technique has features, such as temporal scalability and spatial scalability, on video encoding. The GOP of the SVC technique has an obvious layer structure nature, and different frames are distinguished in accordance with different importance levels. The SVC technique is conventional and thus, will not be repeated. After the receiving party receives a frame belonging to an important layer, an available image may be played, without waiting for complete reception of the whole GOP. A fineness degree of the image played at the receiving party varies with the completeness of the GOP.

The plurality of packets generated by the encoding operation of the video encoding circuit 110 have a GOP structure, wherein a group of picture (GOP) in the GOP structure includes a plurality of layers. A GOP structure including 8 frames with three layers is illustrated in FIG. 4 as an example. In the same GOP, a 0^{th} frame belongs to a 0^{th} layer L0, a 4^{th} frame belongs to a 1^{st} layer L1, a 2^{nd} frame belongs to a 2^{nd} layer L2, and a 1^{st} frame, a 3^{rd} frame, a 5^{th} frame and a 7^{th} frame belong to a 3^{rd} layer L3. It is necessary to refer to the frame belonging to the 2^{nd} layer L2 when the frames belonging to the 3^{rd} layer L3 are decoded. It is necessary to refer to the frame belonging to the 1^{st} layer L1 when the frame belonging to the 2^{nd} layer L2 is decoded. It is necessary to refer to the frame belonging to the 0^{th} layer L0 when the frame belonging to the 1^{st} layer L1 is decoded. Thereby, the importance levels of the packets are decreased as the layers of the GOP structure are increased. If the receiving party only receives the frames belonging to the 0^{th} layer L0 to the 2^{nd} layer L2, the video played by the receiving party still has its completeness, but lacks details related to the 3^{rd} layer L3. It is noted that different numbers of layers can be implemented in other embodiments.

At any time point, each of the packets of the video stream VS1 may be marked with different importance levels. In addition, the video encoding circuit 110 may define the layers L0 to L3 to have different important levels. For example, based on at least two of the layers included in the GOP structure encoded by the SVC technique, each of the packets of the video stream VS1 may be marked with different importance levels, and the video encoding circuit 110 may define a part of the layers L0 to L3 to have a first level of importance and define another part of the layers L0 to L3 to have a second level of importance. Therein, the second level of importance is lower than the first level of importance. For example, in some application scenarios, the packets belonging to the 0^{th} layer L0 to the 2^{nd} layer L2 are defined to have the first level of importance, and the packets belonging to the 3^{rd} layer L3 are defined to have the second level of importance. In some other application scenarios, the packets belonging to the 0^{th} layer L0 to the 1^{st} layer L1 are defined to have the first level of importance, and the packets belonging to the 2^{nd} layer L2 to the 3^{rd} layer L3 are defined to have the second level of importance. In yet other application scenarios, the packets belonging to the 0^{th} layer L0 are defined to have the first level of importance, and the packets belonging to the 1^{st} layer L1 to the 3^{rd} layer L3 are defined to have the second level of importance. For the packets of the video stream VS1 which have different importance levels, the wireless transmitter circuit 120 may provide protection in different degrees (which may refer to the description related to FIG. 3 for details). Thereby, the wireless video transmission apparatus 100 may achieve stream flow adjustment and quality maintenance at any time.

In some embodiments, the video encoding circuit 110 may further determine whether to drop the packets belonging to one or more less-important layers, which may be determined according to the transmission state message TSM of the wireless transmitter circuit 120. For example, the video encoding circuit 110 may further determine whether to drop the packets belonging to the layers having the second level of importance according to the transmission state message TSM of the wireless transmitter circuit 120. When the transmission state message TSM indicates that the transmission state of the wireless transmission channel 10 is good, the video encoding circuit 110 may employ the packets belonging to the layers having the first level of importance and the packets belonging to the layers having the second level of importance as the video stream VS1 to output to the wireless transmitter circuit 120. When the transmission state message TSM indicates that the transmission state of the wireless transmission channel 10 is poor, the video encoding circuit 110 may employ the packets belonging to the layers having the first level of importance as the video stream VS1 to output to the wireless transmitter circuit 120 and drop the packets belonging to the layers having the second level of importance. Thereby, the video encoding circuit 110 may dynamically adjust the bit rate of the video stream VS1 transmitted to the wireless transmitter circuit 120 according to the transmission state message TSM of the wireless transmitter circuit 120.

In some embodiments, responsive to different quality conditions of the transmission state of the wireless transmission channel 10, the video encoding circuit 110 can define the layers L0 to L3 as the layers having different levels of importance. For example, the video encoding circuit 110 may, based on the indication of the transmission state message TSM of the wireless transmitter circuit 120 about the quality of the transmission state of the wireless transmission channel 10, define the layers L0 to L3 as the layers having the first level of importance or the layers having the second level of importance. For example, when the transmission state message TSM of the wireless transmitter circuit 120 indicates that the transmission state of the wireless transmission channel 10 is good, the video encoding circuit 110 may define all of the layers L0 to L3 as the layers having the first level of importance. When the transmission state message TSM of the wireless transmitter circuit 120 indicates that the transmission state of the wireless transmission channel 10 is poor, the video encoding circuit 110 may define a first part of the layers L0 to L3 as the layers having the first level of importance and define a second part of the layers L0 to L3 as the layers having the second level of importance.

When the transmission state of the wireless transmission channel 10 is good, for example, when the transmission state message TSM of the wireless transmitter circuit 120 indicates that the transmission state of the wireless transmission channel 10 is good, the video encoding circuit 110 may employ the packets belonging to the layers having the first level of importance and the packets belonging to the layers having the second level of importance as the video stream VS1 to output to the wireless transmitter circuit 120. When the transmission state message TSM of the wireless transmitter circuit 120 indicates that the transmission state of the wireless transmission channel 10 is poor, the video encoding circuit 110 may employ the packets belonging to the layers having the first level of importance as the video stream VS1 to output to the wireless transmitter circuit 120 and drop the packets belonging to the layers having the second level of importance. It is noted that two levels of importance are used for purpose of explanation, and different numbers of levels of importance can be realized in other embodiments.

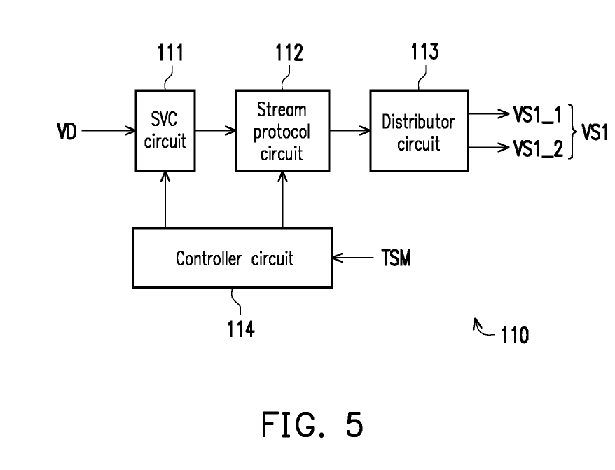

FIG. 5 is a schematic circuit block diagram illustrating the video encoding circuit depicted in FIG. 1 according to an embodiment of the invention. In the embodiment illustrated in FIG. 3, the video encoding circuit 110 includes a scalable video encoding (SVC) circuit 111, a stream protocol circuit 112, a distributor circuit 113 and a controller circuit 114. The SVC circuit 111 is configured to perform the encoding operation on the video data VD by using the SVC technique to generate the plurality of packets. Thereby, the packets have a GOP structure, wherein a GOP in the GOP structure includes a plurality of layers.

The stream protocol circuit 112 is coupled to the SVC circuit 111 to receive the packets. The stream protocol circuit 112 is configured to define a first part of the layers (e.g., the layers L0 to L3 illustrated in FIG. 4) to have the first level of importance and define a second part of the layers to have the second level of importance lower than the first level of importance. The stream protocol circuit 112 may further determine whether to employ the packets belonging to the layers having the first level of importance as the video stream and drop the packets belonging to the layers having the second level of importance according to the adjustment signal of the controller circuit 114.

The controller circuit 114 is coupled to the stream protocol circuit 112 to provide the adjustment signal. The controller circuit 114 controls the stream protocol circuit 112 according to the transmission state message TSM of the wireless transmitter circuit 120, so as to determine whether to drop the packets belonging to the layers having the second level of importance.

The distributor circuit 113 is coupled to the stream protocol circuit 112 to receive the video stream. The distributor circuit 113 is configured to give importance definitions to different packets of the video stream for the stream protocol circuit 112, so as to at least divide the video stream VS1 into a first-priority stream VS1_1 and a second-priority stream VS1_2. The distributor circuit 113 outputs the first-priority stream VS1_1 and the second-priority stream VS1_2 to the wireless transmitter circuit 120.

In the embodiment illustrated in FIG. 5, the controller circuit 114 further provides a control signal to the SVC circuit 111 according to the transmission state message TSM of the wireless transmitter circuit 120. The SVC circuit 111 correspondingly adjusts a resolution of the encoding operation, a quantization parameter of the encoding operation or a frame rate of the encoding operation according to the control signal of the controller circuit 114.

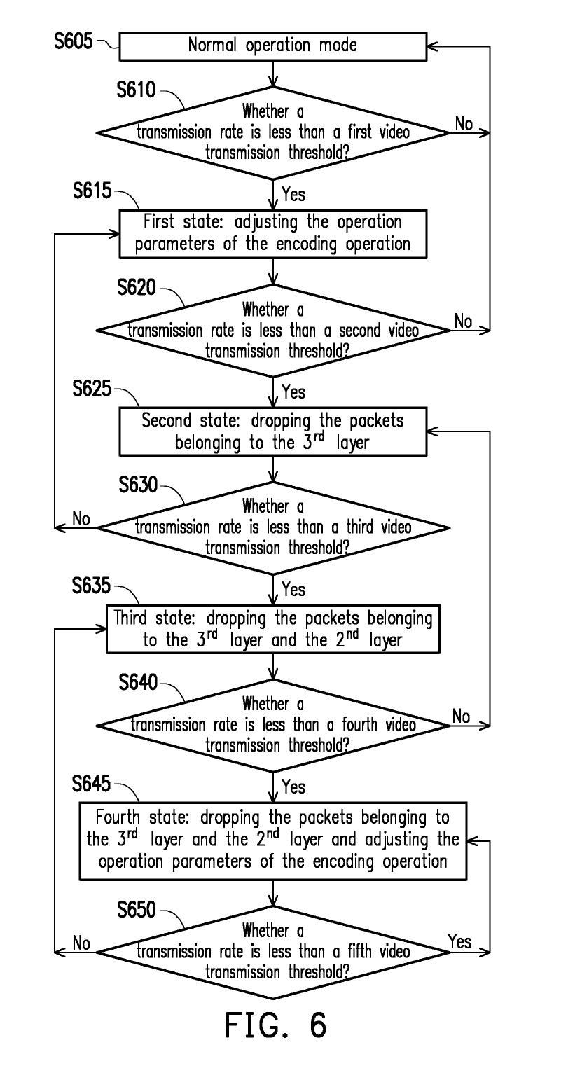

FIG. 6 is a flowchart illustrating a wireless video transmission method according to another embodiment of the invention. The method shown in FIG. 6 is explained with the configuration shown in FIG. 5 but is not limited thereto. Referring to FIG. 5 and FIG. 6, in step S605, the controller circuit 114 is operated in a normal or original operation mode. In the normal operation mode, the controller circuit 114 neither adjusts operation parameters of an encoding operation of the SVC circuit 111 according to the transmission state message TSM, nor controls the stream protocol circuit 112 to drop any packet according to the transmission state message TSM. Namely, the video encoding circuit 110 may perform an available encoding operation known in the art and/or other encoding operations in the normal operation mode.

In the normal operation mode, the video encoding circuit 114 may determine whether a transmission rate of the video stream is less than a first video transmission threshold according to the transmission state message TSM (step S610). The first video transmission threshold may be determined based on a design requirement. When the transmission rate of the video stream is not less than the first video transmission threshold (i.e., the determination result of step S610 is No), the controller circuit 114 is maintained in the normal operation mode (step S605). When the transmission rate of the video stream is less than the first video transmission threshold (i.e., the determination result of step S610 is Yes), the controller circuit 114 may perform step S615.

In step S615, the controller circuit 114 is operated in a first state. In the first state, the controller circuit 114 may correspondingly adjust the operation parameters of the encoding operation of the SVC circuit 111 according to the transmission state message TSM, but not control the stream protocol circuit 112 to drop any packet according to the transmission state message TSM. For example, the SVC circuit 111 may adjust the bit rate by adjusting one or more operation parameters, such as the resolution, in the first state. During the process of reducing the bit rate, the quantization parameter may be accordingly increased. When the quantization parameter is increased to a certain extent, the image details will be obviously much lost. Therefore, the range for adjusting the operation parameters is limited. In the first state, the controller circuit 114 may determine whether the transmission rate of the video stream is less than a second video transmission threshold according to the transmission state message TSM (step S620). When the transmission rate of the video stream is not less than the second video transmission threshold (i.e., the determination result of step S620 is No), it means that the quality of the wireless transmission channel 10 turns better, and thus, the controller circuit 114 may return to the normal operation mode (step S605). When the transmission rate of the video stream is still less than the second video transmission threshold after the controller circuit 114 adjusts the operation parameters of the SVC circuit 111 (i.e., the determination result of step S620 is Yes), the controller circuit 114 may perform step S625.

In step S625, the controller circuit 114 is operated in a second state. In the second state, the controller circuit 114 may control the stream protocol circuit 112 to drop the packets belonging to one or more certain layers such as the 3^{rd} layer L3 according to the transmission state message TSM, but may not correspondingly adjust the operation parameters of the encoding operation of the SVC circuit 111 according to the transmission state message TSM. By dropping the packets belonging to the 3^{rd} layer L3 and transmitting the packets belonging to other layers, the video encoding circuit 110 may retain the complete SVC structure and reduce the demands for transmission bandwidths at the same time. In the second state, the controller circuit 114 may determine whether the transmission rate of the video stream is less than a third video transmission threshold according to the transmission state message TSM (step S630). When the transmission rate of the video stream is not less than the third video transmission threshold (i.e., the determination result of step S630 is No), it means that the quality of the wireless transmission channel 10 turns better, and thus, the controller circuit 114 may return to the first state (step S615). If the transmission rate of the video stream is still less than the third video transmission threshold after the packets belonging to the 3^{rd} layer L3 are dropped (i.e., the determination result of step S630 is Yes), the controller circuit 114 may perfonn step S635.

In step S635, the controller circuit 114 is operated in a third state. In the third state, the controller circuit 114 may control the stream protocol circuit 112 and drop the packets belonging to more layers such as the 2^{nd} layer L2 to the 3^{rd} layer L3 according to the transmission state message TSM, but not correspondingly adjust the operation parameters of the encoding operation of the SVC circuit 111 according to the transmission state message TSM. By dropping the packets belonging to the 2^{nd} layer L2 to the 3^{rd} layer L3 and transmitting the packets belonging to other layers, the video encoding circuit 110 may retain the complete SVC structure and reduce the demands for transmission bandwidths at the same time. In the third state, the controller circuit 114 may determine whether the transmission rate of the video stream is less than a fourth video transmission threshold according to the transmission state message TSM (step S640). When the transmission rate of the video stream is not less than the fourth video transmission threshold (i.e., the determination result of step S640 is No), it represents that the quality of the wireless transmission channel 10 turns better, and thus, the controller circuit 114 may return to the second state (step S625). If the transmission rate of the video stream is still less than the fourth video transmission threshold after the packets belonging to the 2^{nd} layer L2 to the 3^{rd} layer L3 are dropped (i.e., the determination result of step S640 is Yes), the controller circuit 114 may perform step S645.

In step S645, the controller circuit 114 is operated in a fourth state. In the fourth state, the controller circuit 114 may control the stream protocol circuit 112 to drop the packets belonging to the 2^{nd} layer L2 to the 3^{rd} layer L3 according to the transmission state message TSM and correspondingly adjust the operation parameters of the encoding operation of the SVC circuit 111 according to the transmission state message TSM, so as to dynamically adjust the bit rate of the video stream VS1. In the fourth state, the controller circuit 114 may determine whether the transmission rate of the video stream is less than a fifth video transmission threshold according to the transmission state message TSM (step S650). When the transmission rate of the video stream is not less than the fifth video transmission threshold (i.e., the determination result of step S650 is No), it means that the quality of the wireless transmission channel 10 turns better, and thus, the controller circuit 114 may return to the third state (step S635). If the transmission rate of the video stream is still less than the fifth video transmission threshold (i.e., the determination result of step S650 is Yes), the controller circuit 114 is maintained in the fourth state (step S645).

It is noted that the respective values of the first video transmission threshold, the second video transmission threshold, the third video transmission threshold, the fourth video transmission threshold, and the fifth video transmission threshold can be different or the same according to design requirements. In addition, five steps are implemented to compare the transmission rate of the video stream with five video transmission thresholds in the embodiment. However, in alternative embodiments, different numbers of steps can be implemented to compare the transmission rate of the video stream with different numbers of video transmission thresholds. Moreover, different approaches to adjust the bit rate may be adopted in different states, not limited to the above disclosure for purpose of explanation only.

The blocks of the video encoding circuit 110, the SVC circuit 111, the stream protocol circuit 112, the distributor circuit 113, the controller circuit 114, the wireless transmitter circuit 120 and/or the system circuit 121 may be implemented not only by the logic circuits (i.e., the hardware), but also by software through a central processing unit (CPU). In the latter scenario, the related functions of the video encoding circuit 110, the SVC circuit 111, the stream protocol circuit 112, the distributor circuit 113, the controller circuit 114, the wireless transmitter circuit 120 and/or the system circuit 121 may be implemented as programming codes of the software (i.e., the programs). The video encoding circuit 110, the SVC circuit 111, the stream protocol circuit 112, the distributor circuit 113, the controller circuit 114, the wireless transmitter circuit 120 and/or the system circuit 121 may be implemented by using general purpose programming languages (e.g., C or C++) or other suitable programming languages. The aforementioned software (i.e., the programs) may be accessed by a computer (or the CPU) and recorded/stored in a read only memory (ROM), a storage device (or referred to as a recording medium) and/or a random access memory (RAM). Meanwhile, the programs may be accessed and executed from the recording medium through the computer (or the CPU) to accomplish the related functions. As for the recording medium, a non-transitory computer readable medium, such as a tape, a disk, a card, a semi-conductor memory or a programming logic circuit, may be used. In addition, the programs may be provided to the computer (or the CPU) through any transmission medium (e.g., a communication network or radio waves). The communication network is, for example, the Internet, wired communication, wireless communication or other communication media.

In different application scenarios, the related functions of the video encoding circuit 110, the SVC circuit 111, the stream protocol circuit 112, the distributor circuit 113, the controller circuit 114, the wireless transmitter circuit 120 and/or the system circuit 121 may be implemented in a form of software, firmware or hardware by utilizing general purpose programming languages (e.g., C or C++), hardware description languages (e.g., Verilog HDL or VHDL) or other suitable programming languages. In terms of the hardware implementation, one or more controllers, micro-controllers, application-specific integrated circuits (ASICs), digital signal processors (DSPs), field programmable gate arrays (FPGAs) and/or other various logic blocks, modules and circuits in other processing units may be employed to implement or execute the aforementioned functions of the embodiments of the invention. Moreover, the apparatus and the method of the invention may be implemented by a combination of hardware and software.

Based on the above, the wireless video transmission apparatus, the video encoding circuit and the wireless video transmission method provided by the embodiments of the invention combines features of the wireless transmitter circuit and the video encoding circuit. The wireless transmitter circuit 120 can provide the transmission state message to the video encoding circuit according to the transmission state of the wireless transmission channel. The video encoding circuit can dynamically adjust the bit rate of the video stream according to the transmission state message TSM. When the quality of the wireless transmission channel is poor, the bit rate of the video stream can be adaptively adjusted according to the transmission state of the wireless transmission channel, for example, by adjusting the operation parameters of the encoding operation and/or preferentially transmitting more important pockets of the video stream. Thereby, when the quality of the wireless transmission channel is poor, the wireless video transmission apparatus and the video encoding circuit can effectively improve the image quality displayed at the receiving party.

Although the invention has been disclosed by the above embodiments, they are not intended to limit the invention. It will be apparent to one of ordinary skill in the art that modifications and variations to the invention may be made without departing from the spirit and scope of the invention. Therefore, the scope of the invention will be defined by the appended claims.

What is claimed is:

1. A wireless video transmission apparatus, comprising:
a wireless transmitter circuit, configured to transmit a video stream with a bit rate to a wireless transmission channel and provide a transmission state message according to a transmission state of the wireless transmission channel; and
a video encoding circuit, coupled to the wireless transmitter circuit to receive the transmission state message, configured to perform an encoding operation on video data to generate the video stream to the wireless transmitter circuit and dynamically adjust the bit rate of the video stream delivered to the wireless transmitter circuit according to the transmission state message.

2. The wireless video transmission apparatus according to claim 1, wherein the encoding operation gives importance definitions to different packets of the video stream, so as to at least divide the video stream into at least one first-priority stream and at least one second-priority stream, wherein the priority of the at least one first-priority stream is higher than the priority of the at least one second-priority stream.

3. The wireless video transmission apparatus according to claim 2, wherein the wireless transmitter circuit comprises:
a system circuit, coupled to the video encoding circuit to receive the video stream, wherein the system circuit provides a first-priority socket for receiving the at least one first-priority stream of the video stream, provides a second-priority socket for receiving the at least one second-priority stream of the video stream, and provides a buffer memory for temporarily storing the at least one first-priority stream and the at least one second-priority stream; and
a wireless transmitter, coupled to the system circuit to receive the stream temporarily stored in the buffer memory, and configured to transmit the stream to the wireless transmission channel and provide the transmission state message to the video encoding circuit according to the transmission state of the wireless transmission channel.

4. The wireless video transmission apparatus according to claim 3, wherein the system circuit temporarily stores the at least one first-priority stream into the buffer memory and drops the at least one second-priority stream when a used space of the buffer memory reaches a first threshold.

5. The wireless video transmission apparatus according to claim 4, wherein the system circuit clears the second-priority stream temporarily stored in the buffer memory when the used space of the buffer memory reaches a second threshold.

6. The wireless video transmission apparatus according to claim 1, wherein the video encoding circuit correspondingly adjusts one or more operation parameters of the encoding operation according to the transmission state message of the wireless transmitter circuit, so as to dynamically adjust the bit rate of the video stream delivered to the wireless transmitter circuit.

7. The wireless video transmission apparatus according to claim 6, wherein the one or more operation parameters comprise at least one of a resolution parameter, a quantization parameter and a frame rate parameter.

8. The wireless video transmission apparatus according to claim 1, wherein a plurality of packets generated by the encoding operation have a plurality of layers, and the video encoding circuit defines a part of the layers to have a first level of importance and defines other one or more of the layers to have a second level of importance lower than the first level of importance.

9. The wireless video transmission apparatus according to claim 8, wherein the video encoding circuit is configured to perform the encoding operation by using a scalable video coding (SVC) technique, such that the plurality of packets generated by the encoding operation have a group of pictures (GOP) structure, wherein a GOP in the GOP structure comprises the plurality of layers.

10. The wireless video transmission apparatus according to claim 8, wherein the video encoding circuit determines whether to employ the packets belonging to the layers having the first level of importance as the video stream to output to the wireless transmitter circuit and drop the packets belonging to the layers having the second level of importance according to the transmission state message of the wireless transmitter circuit, so as to dynamically adjust the bit rate of the video stream delivered to the wireless transmitter circuit.

11. The wireless video transmission apparatus according to claim 8, wherein the video encoding circuit defines the layers to be the layers having the first level of importance or the layers having the second level of importance based on indication of the transmission state message of the wireless transmitter circuit about quality of the transmission state of the wireless transmission channel.

12. The wireless video transmission apparatus according to claim 11, wherein the video encoding circuit defines all of the layers as the layers having the first level of importance when the transmission state message of the wireless transmitter circuit indicates that the transmission state of the wireless transmission channel is good.

13. The wireless video transmission apparatus according to claim 12, wherein the video encoding circuit employs the packets belonging to the layers having the first level of importance and the packets belonging to the layers having the second level of importance as the video stream to output to the wireless transmitter circuit when the transmission state message of the wireless transmitter circuit indicates that the transmission state of the wireless transmission channel is good.

14. The wireless video transmission apparatus according to claim 11, wherein the video encoding circuit defines a first part of the layers as the layers having the first level of importance and defines a second part of the layers as the layers having the second level of importance when the transmission state message of the wireless transmitter circuit indicates that the transmission state of the wireless transmission channel is poor.

15. The wireless video transmission apparatus according to claim 14, wherein the video encoding circuit employs the packets belonging to the layers having the first level of importance as the video stream to output to the wireless transmitter circuit and drops the packets belonging to the layers having the second level of importance when the transmission state message of the wireless transmitter circuit indicates that the transmission state of the wireless transmission channel is poor.

16. A video encoding circuit, comprising:
a scalable video encoding (SVC) circuit, configured to perform an encoding operation on video data by using an SVC technique to generate a plurality of packets, wherein the packets have a group of pictures (GOP) structure, and a GOP in the GOP structure comprises a plurality of layers;
a stream protocol circuit, coupled to the SVC circuit to receive the packets, and configured to define a first part of the layers to have a first level of importance and defines a second part of the layers to have a second level of importance lower than the first level of importance, wherein the stream protocol circuit determines whether to employ the packets belonging to the layers having the first level of importance as a video stream and drop the packets belonging to the layers having the second level of importance according to an adjustment signal;
a distributor circuit, coupled to the stream protocol circuit to receive the video stream, and configured to give importance definitions to different packets of the video stream, so as to at least divide the video stream into a first-priority stream and a second-priority stream and output the first-priority stream and the second-priority stream to a wireless transmitter circuit; and
a controller circuit, coupled to the stream protocol circuit to provide the adjustment signal, wherein the controller circuit controls the stream protocol circuit according to a transmission state message of the wireless transmitter circuit, so as to determine whether to drop the packets belonging to the layers having the second level of importance.

17. The video encoding circuit, according to claim 16, wherein the controller circuit further provides a control signal to the SVC circuit according to the transmission state message of the wireless transmitter circuit, and the SVC circuit correspondingly adjusts a resolution of the encoding operation, a quantization parameter of the encoding operation or a frame rate of the encoding operation according to the control signal.

18. A wireless video transmission method, comprising:
transmitting a video stream with a bit rate to a wireless transmission channel by a wireless transmitter circuit;
providing a transmission state message according to a transmission state of the wireless transmission channel by the wireless transmitter circuit;
performing an encoding operation on video data by a video encoding circuit to generate the video stream to the wireless transmitter circuit; and
dynamically adjusting the bit rate of the video stream delivered to the wireless transmitter circuit according to the transmission state message by the video encoding circuit.

19. The wireless video transmission method according to claim 18, wherein the step of performing the encoding operation comprises:
giving importance definitions to different packets of the video stream, so as to at least divide the video stream into at least one first-priority stream and at least one second-priority stream, wherein the priority of the at least one first-priority stream is higher than the priority of the at least one second-priority stream.

20. The wireless video transmission method according to claim 19, wherein the step of transmitting the video stream to the wireless transmission channel comprises:
providing a first-priority socket for receiving the at least one first-priority stream of the video stream by a system circuit;
providing a second-priority socket for receiving the at least one second-priority stream of the video stream by the system circuit;
providing a buffer memory for temporarily storing the at least one first-priority stream and the at least one second-priority stream by the system circuit; and
transmitting the stream temporarily stored in the buffer memory to the wireless transmission channel by a wireless transmitter.

21. The wireless video transmission method according to claim 20, wherein the step of transmitting the video stream to the wireless transmission channel further comprises:
temporarily storing the at least one first-priority stream into the buffer memory and dropping the at least one second-priority stream by the system circuit when a used space of the buffer memory reaches a first threshold.

22. The wireless video transmission method according to claim 21, wherein the step of transmitting the video stream to the wireless transmission channel further comprises:
clearing the at least one second-priority stream temporarily stored in the buffer memory by the system circuit when the used space of the buffer memory reaches a second threshold.

23. The wireless video transmission method according to claim 18, wherein the step of dynamically adjusting the bit rate of the video stream delivered to the wireless transmitter circuit comprises:
correspondingly adjusting one or more operation parameters of the encoding operation according to the transmission state message of the wireless transmitter circuit by the video encoding circuit, so as to dynamically adjust the bit rate of the video stream delivered to the wireless transmitter circuit.

24. The wireless video transmission method according to claim 23, wherein the one or more operation parameters comprise at least one of a resolution parameter, a quantization parameter and a frame rate parameter.

25. The wireless video transmission method according to claim 18, wherein a plurality of packets generated by the encoding operation have a plurality of layers, and the video encoding circuit defines a part of the layers to have a first level of importance and defines other one or more of the layers to have a second level of importance lower than the first level of importance.

26. The wireless video transmission method according to claim 25, wherein the step of performing the encoding operation comprises:
performing the encoding operation by using a scalable video coding technique, such that the plurality of packets generated by the encoding operation is a group of pictures (GOP) structure, wherein a GOP in the GOP structure comprises the plurality of layers.

27. The wireless video transmission method according to claim 25, wherein the step of dynamically adjusting the bit rate of the video stream delivered to the wireless transmitter circuit comprises:
determining whether to employ the packets belonging to the layers having the first level of importance as the video stream to output to the wireless transmitter circuit and drop the packets belonging to the layers having the second level of importance according to the transmission state message of the wireless transmitter circuit, so as to dynamically adjust the bit rate of the video stream delivered to the wireless transmitter circuit.

28. The wireless video transmission method according to claim 25, wherein the step of performing the encoding operation comprises:
defining the layers to be the layers having the first level of importance or the layers having the second level of importance based on indication of the transmission state message of the wireless transmitter circuit about quality of the transmission state of the wireless transmission channel.

29. The wireless video transmission method according to claim 28, wherein the step of defining the layers to be the layers having the first level of importance comprises:
defining all of the layers as the layers having the first level of importance by the video encoding circuit when the transmission state message of the wireless transmitter circuit indicates that the transmission state of the wireless transmission channel is good.

30. The wireless video transmission method according to claim 29, wherein the step of dynamically adjusting the bit rate of the video stream delivered to the wireless transmitter circuit comprises:
employing the packets belonging to the layers having the first level of importance and the packets belonging to the layers having the second level of importance as the video stream to output to the wireless transmitter circuit when the transmission state message of the wireless transmitter circuit indicates that the transmission state of the wireless transmission channel is good.

31. The wireless video transmission method according to claim 28, wherein the step of defining the layers having the first level of importance or the layers having the second level of importance further comprises:
defining a first part of the layers as the layers having the first level of importance and defining a second part of the layers as the layers having the second level of importance by the video encoding circuit when the transmission state message of the wireless transmitter circuit indicates that the transmission state of the wireless transmission channel is poor.

32. The wireless video transmission method according to claim 31, wherein the step of dynamically adjusting the bit rate of the video stream delivered to the wireless transmitter circuit comprises:
employing the packets belonging to the layers having the first level of importance as the video stream to output to the wireless transmitter circuit and dropping the packets belonging to the layers having the second level of importance when the transmission state message of the wireless transmitter circuit indicates that the transmission state of the wireless transmission channel is poor.
